(19) United States
(12) Patent Application Publication
(10) Pub. No.: US 2015/0137482 A1
(43) Pub. Date: May 21, 2015

(54) INTELLIGENT HITCH APPARATUS FOR VEHICLES

(71) Applicant: TeleSwivel, LLC, Durham, NC (US)

(72) Inventors: William David Woolf, Durham, NC (US); Carl Michael Anderson, Wake Forest, NC (US)

(21) Appl. No.: 14/541,722

(22) Filed: Nov. 14, 2014

Related U.S. Application Data
(60) Provisional application No. 61/905,544, filed on Nov. 18, 2013.

(51) Int. Cl. B60D 1/24

(52) U.S. Cl. CPC B60D 1/24
USPC 280/448

(57) ABSTRACT

A hitch apparatus for a vehicle includes a microcontroller unit, a drawbar, and a coupling apparatus secured within the drawbar via a pin. The pin and/or the drawbar includes one or more force sensors, each configured to measure a force vector on the pin and/or drawbar during towing of a trailer or other vehicle attached to the coupling apparatus. Each force sensor is electrically connected to the microcontroller unit, and the microcontroller unit is configured to receive force measurement data from each force sensor and process the data for transfer to a vehicle control system via a controller area network bus associated with the vehicle. The microcontroller unit may determine if one or more threshold forces have been exceeded and trigger one or more corrective actions by the vehicle control system in response to determining that a threshold force has been exceeded.

### RELATED APPLICATION

This application claims the benefit of and priority to U.S. Provisional Patent Application No. 61/905,544 filed Nov. 18, 2013, the disclosure of which is incorporated herein by reference as if set forth in its entirety.

### FIELD OF THE INVENTION

The present invention relates generally to vehicle towing and, more particularly, to hitch apparatus for towing vehicles.

### BACKGROUND

A hitch apparatus coupling a vehicle to a trailer or other towed vehicle is subjected to various forces during towing. Exemplary forces on a hitch apparatus include, the downward force of the trailer's tongue, referred to as “tongue weight”, the upward force on the trailer tongue resulting from uneven road surfaces or improper trailer loading, lateral forces resulting from trailer yaw, torque resulting from trailer rotation about its lateral axis, and forces caused by vehicle acceleration (i.e., tensile forces) and deceleration (i.e., compressive forces). If any of these forces becomes excessive, it may be difficult to tow a trailer or other vehicle in a balanced and stable manner. In addition, excessive forces caused by towing may contribute to excessive wear and tear on braking and transmission components of a towing vehicle.

Unbalanced and unstable trailer operation require inputs to vehicle control systems to overcome and return the trailer to a safe operating state. In traditional vehicle operations, these inputs would come from the vehicle operator. With the emergence of automated vehicle control systems, corrections to unbalanced and safe operation required by the dynamic forces acting on the trailer, can be made without driver intervention

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

According to some embodiments of the present invention, a hitch apparatus for a vehicle includes a microcontroller unit, a drawbar, and a coupling apparatus secured within the drawbar, for example, via a pin. The pin includes one or more force sensors forming a load cell transducer, each force sensor configured to measure a force vector on the pin during towing of a trailer or other vehicle attached to the coupling apparatus. Each pin force sensor is electrically connected to the microcontroller unit, and the microcontroller unit is configured to receive force measurement data from each pin force sensor and process the data for transfer to a vehicle control system. The microcontroller unit may also determine if a threshold force on the pin has been exceeded and trigger a corrective action by the vehicle control system in response to determining that the threshold force has been exceeded. In some embodiments, the microcontroller unit is configured to communicate with the vehicle control system via a controller area network (CAN) bus associated with the vehicle. In some embodiments, the pin includes an electrical cable that connects each pin force sensor to the microcontroller unit. However, in other embodiments, each pin force sensor may wirelessly communicate with the microcontroller unit.

In some embodiments, the drawbar includes one or more force sensors forming a load cell transducer, each force sensor configured to measure a force vector on the drawbar during towing of a trailer or other vehicle attached to the coupling apparatus. Each drawbar force sensor is electrically connected to the microcontroller unit, and the microcontroller unit is configured to receive force measurement data from each drawbar force sensor and process the data for transfer to a vehicle control system. The microcontroller unit may also determine if a threshold force on the drawbar has been exceeded and trigger a corrective action by the vehicle control system in response to determining that the threshold force has been exceeded. In some embodiments, the drawbar includes an electrical cable that connects each drawbar force sensor to the microcontroller unit. However, in other embodiments, each drawbar force sensor may wirelessly communicate with the microcontroller unit.

In some embodiments, the hitch apparatus includes a housing that defines a cavity, and the drawbar is movably disposed within the cavity and movable relative to the housing between retracted and extended positions. A guide pin is associated with the drawbar and limits how far the drawbar can be extended from the housing. A locking mechanism is operably secured to the housing that releasably engages the guide pin to maintain the drawbar in a retracted position. The guide pin includes one or more force sensors forming a load cell transducer, each force sensor configured to measure a force vector on the guide pin during towing of a trailer or other vehicle attached to the coupling apparatus. Each guide pin force sensor is electrically connected to the microcontroller unit, and the microcontroller unit is configured to receive force measurement data from each guide pin force sensor and process the data for transfer to a vehicle control system. The microcontroller unit may also determine if a threshold force on the guide pin has been exceeded and trigger a corrective action by the vehicle control system in response to determining that the threshold force has been exceeded. In some embodiments, the guide pin includes an electrical cable that connects each guide pin force sensor to the microcontroller unit. However, in other embodiments, each guide pin force sensor may communicate wirelessly with the microcontroller unit.

In other embodiments, the hitch apparatus includes a housing that defines a cavity, and the drawbar is movably disposed within the cavity and movable relative to the housing between retracted and extended positions. A locking mechanism is operably secured to the housing and includes a locking pin configured to releasably engage the drawbar and maintain the drawbar in a retracted position. The locking pin includes one or more force sensors forming a load cell transducer, each force sensor configured to measure a force vector on the locking pin via the drawbar during towing of a trailer or other vehicle attached to the coupling apparatus. Each locking pin force sensor is electrically connected to the microcontroller unit, and the microcontroller unit is configured to receive force measurement data from each locking pin force sensor and process the data for transfer to a vehicle control system. The microcontroller unit may also determine if a threshold force on the locking pin has been exceeded and trigger a corrective action by the vehicle control system in response to determining that the threshold force has been exceeded. In some embodiments, the locking pin includes an electrical cable that connects each locking pin force sensor to the microcontroller unit. However, in other embodiments, each locking pin force sensor may wirelessly communicate with the microcontroller unit.

According to some embodiments of the present invention, a hitch apparatus for a vehicle includes a microcontroller unit, a drawbar, and a coupling apparatus secured within the drawbar via a pin. The drawbar includes one or more force sensors forming a load cell transducer, each force sensor configured to measure a force vector on the drawbar during towing of a trailer or other vehicle attached to the coupling apparatus. Each drawbar force sensor is electrically connected to the microcontroller unit via a first electrical cable. The pin includes one or more force sensors forming a load cell transducer, each force sensor configured to measure a force vector on the pin during towing of a trailer or other vehicle attached to the coupling apparatus. Each pin force sensor is electrically connected to the microcontroller unit via a second electrical cable. The microcontroller unit is configured to receive force measurement data from each drawbar force sensor and each pin force sensor and process the data for transfer to a vehicle control system. The microcontroller unit may also determine if a threshold force on the drawbar and/or on the pin has been exceeded and trigger a corrective action by the vehicle control system in response to determining that the threshold force has been exceeded. In some embodiments, the microcontroller unit is configured to communicate with the vehicle control system via a controller area (CAN) network bus associated with the vehicle.

According to other embodiments of the present invention, a hitch apparatus for a vehicle includes a microcontroller unit, a housing that defines a cavity, a drawbar movably disposed within the cavity and movable relative to the housing between retracted and extended positions, and a coupling apparatus secured within the drawbar. The hitch apparatus also includes a guide pin associated with the drawbar that limits how far the drawbar can be extended from the housing, and a locking mechanism operably secured to the housing that releasably engages the guide pin to maintain the drawbar in a retracted position. The drawbar includes one or more force sensors forming a load cell transducer, each force sensor configured to measure a force vector on the drawbar and each electrically connected to the microcontroller unit. The guide pin includes one or more force sensors forming a load cell transducer, each force sensor configured to measure a force vector on the guide pin and each electrically connected to the microcontroller unit. The coupling apparatus is secured within the drawbar via a pin, and the pin includes one or more force sensors forming a load cell transducer, each force sensor configured to measure a force vector on the pin and each electrically connected to the microcontroller unit. The microcontroller unit is configured to receive force measurement data from each drawbar force sensor, each guide pin force sensor, and each coupling apparatus pin force sensor, and process the data for transfer to a vehicle control system. The microcontroller unit may also determine if a threshold force on the drawbar and/or on the guide pin and/or on the pin has been exceeded and trigger a corrective action by the vehicle control system in response to determining that the threshold force has been exceeded. In some embodiments, the microcontroller unit is configured to communicate with the vehicle control system via a controller area network bus associated with the vehicle.

According to other embodiments of the present invention, a hitch apparatus for a vehicle includes a microcontroller unit, a housing that defines a cavity, a drawbar movably disposed within the cavity and movable relative to the housing between retracted and extended positions, and a coupling apparatus secured within the drawbar. The hitch apparatus also includes a locking mechanism operably secured to the housing and configured to releasably engage the drawbar and maintain the drawbar in a retracted position. The drawbar includes one or more force sensors forming a load cell transducer, each force sensor configured to measure a force vector on the drawbar, and each electrically connected to the microcontroller unit. The locking mechanism includes a locking pin configured to releasably engage the drawbar. The locking pin includes one or more force sensors forming a load cell transducer, each force sensor configured to measure a force vector on the locking pin, and each electrically connected to the microcontroller unit. The coupling apparatus is secured within the drawbar via a pin. The pin includes one or more force sensors forming a load cell transducer, each force sensor configured to measure a force vector on the pin, and each electrically connected to the microcontroller unit. The microcontroller unit is configured to receive force measurement data from each drawbar force sensor, each locking pin force sensor, and each pin force sensor, and process the data for transfer to a vehicle control system. The microcontroller unit may also determine if a threshold force on the drawbar and/or on the locking pin and/or on the pin has been exceeded and trigger a corrective action by the vehicle control system in response to determining that the threshold force has been exceeded. In some embodiments, the microcontroller unit is configured to communicate with the vehicle control system via a controller area network bus associated with the vehicle.

According to other embodiments of the present invention, a hitch apparatus for a vehicle includes a microcontroller unit, a frame configured to be pivotably secured to the vehicle and pivotable about a first axis, a guide pivotably secured to the frame and pivotable about a second axis that is substantially transverse to the first axis, and a drawbar movably secured to the guide and movable relative to the guide between retracted and extended positions. The drawbar includes one or more force sensors forming a load cell transducer, each force sensor configured to measure a force vector on the drawbar, and each electrically connected to the microcontroller unit. A locking mechanism is operably secured to the frame and includes a locking pin configured to releasably engage the drawbar and maintain the drawbar in a retracted position. The locking pin includes one or more force sensors forming a load cell transducer, each force sensor configured to measure a force vector on the locking pin, and each electrically connected to the microcontroller unit.

A coupling apparatus is secured to the drawbar distal end via at least one fastener. Each fastener includes a force sensor (e.g., a thin film washer, etc.) configured to measure a force vector on the fastener. Each fastener force sensor is electrically connected to the microcontroller unit, and wherein the microcontroller unit is configured to receive force measurement data from each force sensor and process the data for transfer to the vehicle control system.

In some embodiments, at least one wear pad load cell is associated with the drawbar and is configured to measure a force vector on the drawbar. Each wear pad load cell is electrically connected to the microcontroller unit, and the microcontroller unit is configured to receive force measurement data from each wear pad load cell and process the data for transfer to the vehicle control system. Wear pad load cells may be affixed to the guide or to the drawbar. For example, in some embodiments one or more wear pad load cells may be secured to the drawbar and one or more wear pad load cells may be secured to the guide.

The microcontroller unit is configured to receive force measurement data from each drawbar force sensor, each wear pad load cell, each locking pin force sensor, and each coupling apparatus fastener force sensor, and process the data for transfer to a vehicle control system. The microcontroller unit may also determine if a threshold force on the drawbar and/or on the locking pin has been exceeded and trigger a corrective action by the vehicle control system in response to determining that the threshold force has been exceeded. In some embodiments, the microcontroller unit is configured to communicate with the vehicle control system via a controller area network bus associated with the vehicle.

In some embodiments of the present invention, the hitch apparatus includes a user controlled positioning system configured to position the drawbar distal end at a desired position within a three-dimensional coordinate system. In some embodiments, the positioning system includes at least one first actuator configured to pivot the frame about the first axis, and at least one second actuator configured to pivot the guide about the second axis and to extend and retract the drawbar relative to the guide. The first and second actuators may be hydraulic actuators, electrical actuators, or pneumatic actuators, etc.

In some embodiments the at least one first actuator is a hydraulic or pneumatic actuator and a respective differential pressure transducer is in fluid communication with the at least one first actuator to measure forces on the at least one first actuator. Similarly, in some embodiments, the at least one second actuator is a hydraulic or pneumatic actuator and a respective differential pressure transducer is in fluid communication with the at least one second actuator to measure forces on the at least one second actuator. Each differential pressure transducer is electrically connected to the microcontroller unit, and the microcontroller unit is configured to receive force measurement data from each differential pressure transducer and process the data for transfer to the vehicle control system.

According to other embodiments of the present invention, a hitch apparatus for a vehicle includes a microcontroller unit, a frame configured to be pivotably secured to the vehicle, wherein the frame is pivotable about a first axis, a guide pivotably secured to the frame and pivotable about a second axis that is substantially transverse to the first axis, a drawbar movably secured to the guide and movable relative to the guide between retracted and extended positions, and a user controlled positioning system configured to position the drawbar distal end at a desired position within a three-dimensional coordinate system. A distal end of the drawbar has a coupling apparatus or is configured to removably receive a coupling apparatus. The positioning system includes at least one first actuator configured to pivot the frame about the first axis, and at least one second actuator configured to pivot the guide about the second axis and to extend and retract the drawbar relative to the guide. The at least one first and second actuators are hydraulic or pneumatic actuators.

A first differential pressure transducer is in fluid communication with the at least one first actuator and is configured to measure forces exerted on the at least one first actuator during a towing operation. A second differential pressure transducer is in fluid communication with the at least one second actuator and is configured to measure forces exerted on the at least one second actuator during a towing operation. The first and second differential pressure transducers are electrically connected to the microcontroller unit. The microcontroller unit is configured to receive force measurement data from the first and second differential pressure transducers and process the data for transfer to one or more vehicle control systems. The microcontroller unit is configured to determine if a threshold force on the at least one first actuator and/or on the at least one second actuator has been exceeded and trigger a corrective action by the one or more vehicle control systems in response to determining that the threshold force has been exceeded.

It is noted that aspects of the invention described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail below.

### BRIEF DESCRIPTION OF THE DRAWINGS

The accompanying drawings, which form a part of the specification, illustrate some exemplary embodiments. The drawings and description together serve to fully explain the exemplary embodiments.

FIG. 1 is a block diagram of an intelligent hitch apparatus in communication with a vehicle control system, according to some embodiments of the present invention.

FIG. 2A is a perspective view of a coupling apparatus secured within a receiver tube or drawbar and that may be utilized in accordance with embodiments of the present invention.

FIG. 2B is a perspective view of the drawbar of FIG. 2A with the coupling apparatus removed therefrom.

FIG. 3A illustrates a drawbar, such as the drawbar illustrated in FIGS. 2A-2B, that includes a thin film strain gauge as a force sensor for use in detecting forces from a towed vehicle, according to some embodiments of the present invention.

FIG. 3B schematically illustrates the thin film strain gauge of FIG. 3A connected to the microcontroller unit of FIG. 1.

FIG. 4A illustrates a drawbar, such as the drawbar illustrated in FIGS. 2A-2B, that includes multiple compression sensors as force sensors for use in detecting forces from a towed vehicle, according to some embodiments of the present invention.

FIG. 4B schematically illustrates one of the compression sensors of FIG. 4A connected to the microcontroller unit of FIG. 1.

FIG. 5 is a perspective view of a ball coupler apparatus and locking pin that may be utilized in accordance with embodiments of the present invention.

FIG. 6 is a perspective view of a hitch apparatus having a movable drawbar and that may be utilized in accordance with embodiments of the present invention.

FIG. 7 is a top cutaway view of the hitch apparatus of FIG. 6 illustrating the drawbar in an extended and pivoted position. The illustrated hitch apparatus is attached to a vehicle via a frame.

FIG. 8 is a partial side cutaway view of the drawbar of the hitch apparatus of FIG. 6 that illustrates a locking mechanism gripping a guide pin so as to maintain the drawbar in the fully retracted position.

FIG. 9 illustrates the guide pin of FIG. 8 having strain gauges as force sensors positioned at spaced-apart locations, according to some embodiments of the present invention.

FIG. 10 is a perspective view of a hitch apparatus having a movable drawbar and that may be utilized in accordance with embodiments of the present invention.

FIG. 11 is a partial top cutaway view of the hitch apparatus of FIG. 10 illustrating the drawbar locking mechanism.

FIG. 12 illustrates the movable pin associated with the locking mechanism of FIG. 11 and that can incorporate various strain gauge sensors as force sensors, according to some embodiments of the present invention.

FIG. 13 is a perspective view of an articulating hitch apparatus having a movable drawbar and that may be utilized in accordance with embodiments of the present invention.

FIG. 14 is a partial side cutaway view of a coupling apparatus secured within a drawbar of a hitch apparatus and that may be utilized in accordance with embodiments of the present invention.

FIG. 15 illustrates the pin that secures the coupling apparatus of FIG. 14 within the drawbar and that includes strain gauges as force sensors positioned at spaced-apart locations, according to some embodiments of the present invention.

FIG. 16 is a top plan view of an articulating hitch apparatus having a movable drawbar and that may be utilized in accordance with embodiments of the present invention.

FIG. 17 is a side elevation view of the articulating hitch apparatus of FIG. 16 taken along lines 17-17.

FIGS. 18 and 19 illustrate forces that are incurred by the articulating hitch apparatus of FIG. 16 when towing a trailer or other vehicle.

FIG. 20 illustrates various locations where force sensors may be utilized with the articulating hitch apparatus of FIG. 16, according to some embodiments of the present invention.

FIG. 21 is a side elevation of a coupling apparatus that may be utilized with the articulating hitch apparatus of FIG. 16, and the location of force sensors that may be utilized with the coupling apparatus, according to some embodiments of the present invention.

FIGS. 21A-21B illustrate force sensors as thin film strain gauge washers that may be utilized in accordance with embodiments of the present invention.

FIG. 22 illustrates various locations where pressure transducers utilized as force sensors may be located in the actuators of the articulating hitch apparatus of FIG. 16, according to some embodiments of the present invention.

FIG. 22A illustrates a port direct mount pressure transducer that may be utilized with an actuator of the articulating hitch apparatus of FIG. 16, according to some embodiments of the present invention.

FIG. 22B illustrates an in-line mount pressure transducer that may be utilized with an actuator of the articulating hitch apparatus of FIG. 16, according to some embodiments of the present invention.

### DETAILED DESCRIPTION

The present invention will now be described more fully hereinafter with reference to the accompanying figures, in which embodiments of the invention are shown. This invention may, however, be embodied in many different forms and should not be construed as limited to the embodiments set forth herein. Like numbers refer to like elements throughout. In the figures, certain components or features may be exaggerated for clarity, and broken lines may illustrate optional features or elements unless specified otherwise. In addition, the sequence of operations (or steps) is not limited to the order presented in the figures and/or claims unless specifically indicated otherwise. Features described with respect to one figure or embodiment can be associated with another embodiment or figure although not specifically described or shown as such.

It will be understood that when a feature or element is referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that although the terms first and second are used herein to describe various features or elements, these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

The term “about”, as used herein with respect to a value or number, means that the value or number can vary by +/−20%, +/−10%, +/−5%, +/−1%, +/−0.5%, or even +/−0.1%.

The term “force”, as used herein, includes any type of force exerted on a hitch apparatus. Exemplary forces include vertical (up/down) forces caused by trailer tongue weight and lift due to road and/or trailer loads, lateral forces caused by trailer yaw, for example as a result of (tire problems on one side, wind, etc., torque forces due to uneven road/terrain, and compressive forces and tensile forces as a result of deceleration/stopping and acceleration.

The term “force sensor”, as used herein, is intended to include all types of sensors for measuring forces including, but not limited to, strain gauge sensors (e.g., thin film, foil, semiconductor, etc.), compression sensors, piezoelectric force transducers, hydraulic load cells for measuring hydraulic pressure, and pneumatic load cells for measuring pneumatic pressure. Force sensors may also be configured to detect and measure relative change and rate of change of forces acting on a hitch structure/vehicle and to transmit data to a microcontroller unit. Force sensors may also be configured to detect forces within preset thresholds in order to trigger corrective action(s) if one or more threshold forces are exceeded.

The term “vehicle” includes all types of vehicles including, but not limited to, automobiles, trucks, military vehicles, airplanes, trains, etc., and also includes towed vehicles and towing vehicles.

The term “autonomous vehicle”, as used herein, refers to a driverless towing vehicle. An autonomous vehicle includes one or more vehicle control systems configured to receive information regarding, for example, the surrounding terrain, upcoming obstacles, a particular path, etc., and to automatically respond to this information in place of a human operator by commanding a series of maneuvers so that the vehicle is able to negotiate the terrain, avoid the obstacles, or track a particular path with little or no human intervention.

The term “semi-autonomous vehicle”, as used herein, refers to a towing vehicle that has some autonomous features, but that may require an initial input or continuous input from an operator.

The term “vehicle control system” refers to one or more control systems associated with a vehicle including, but not limited to, an engine control system, a transmission control system, a brake control system, a steering control system, a suspension control system, etc. Control systems monitor, control, and/or regulate an area of a vehicle. Control systems use sensors to determine physical parameters such as the engine's rotational speed, the temperature in the passenger compartment, the engine temperature, the tire pressure, etc. Typically, sensors feed data to control systems continuously or substantially continuously during vehicle operation. The measured physical parameters are then compared via an algorithm, for example, with expected values that are stored in the controller or calculated. If the measured value of the parameter does not coincide with the expected value, then the controller uses actuators, for example, to readjust the physical process so that the measured parameters coincide with the expected values. Minor deviations from safe operating forces trigger minor responses (physical adjustments). For example, minor deviations such as trailer yaw due to cross winds invoke minor corrections to braking or steering systems to compensate for the trailer yaw. Unsafe conditions (e.g., forces some predetermined amount outside of an “acceptable” range) could trigger alarms to notify the driver, or even emergency shut down commands.

The term “CAN bus” (Controller Area Network bus) is a vehicle bus standard designed to allow microcontrollers and devices associated with vehicle control systems to communicate with each other within a vehicle without a host computer.

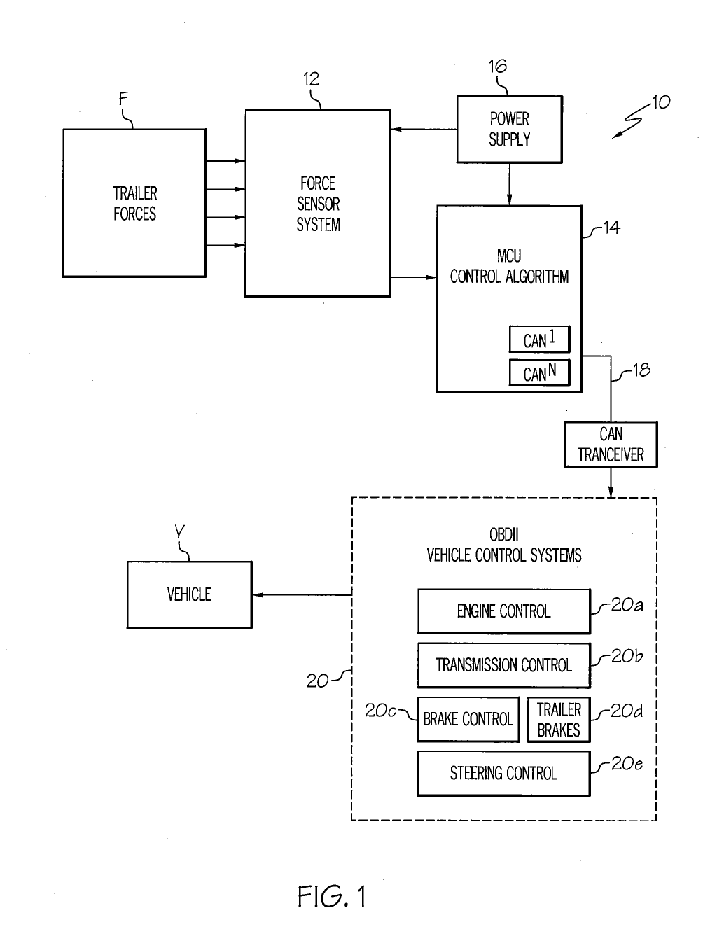

Referring to FIG. 1, according to embodiments of the present invention, a sensor system 10 that may be incorporated into various types of hitch apparatus, is illustrated. The sensor system 10 includes a plurality of force sensors, referred to as the Force Sensor System 12. The force sensors in the Force Sensor System 12 are positioned in various locations of a hitch apparatus, as will be described below, and are configured to detect forces acting on the hitch apparatus and towing vehicle due to interaction with a towed load, such as a trailer or other type of towed vehicle. The sensor system 10 is configured to measure various forces including, but not limited to, lateral forces (e.g., longitudinal tension and compression), vertical forces (e.g., tongue weight), torque resulting from trailer yaw, and transverse thrust on the hitch apparatus.

The sensors in the Force Sensor System 12 are electrically connected to a microcontroller unit 14 and both the microcontroller unit 14 and the Force Sensor System 12 receive power via a power supply 16 (e.g., the electrical system of a towing vehicle). The microcontroller unit 14 is configured to receive force measurement data from the various sensors in the Force Sensor System 12 and process the data for transfer to a vehicle control system (e.g., an OBD II vehicle control system) 20 associated with the towing vehicle V. The microcontroller unit 14 may communicate with the vehicle control system 20 via a controller area network (CAN) bus 18 associated with the vehicle V.

As known to those of skill in the art, a vehicle control system 20 typically includes a plurality of control units associated with various vehicle systems. These control units continuously receive data from the various systems and can make adjustments to the respective systems. For example, steering angle, engine speed, selected gear and braking conditions can be monitored by various sensors. The vehicle control system 20 uses this information to constantly and automatically optimize vehicle traction and stability. For example, torque distribution between the front and rear wheels can be optimized, torque distribution between left and right wheels can be controlled when braking, and engine output can be controlled to maintain a safe level of driving.

The microcontroller unit 14 receives digital force measurement data from the Force Sensor System 12 and processes this data via a control program executing within the microcontroller unit 14 for near real time transfer to a vehicle control system 20. The sensor system alignment and accuracy allows for a new integrated control algorithm to deliver data to a vehicle control system. The control algorithm contains parameters that can indicate excessive or even catastrophic conditions (e.g., excessive tongue weight, blown trailer tire, disconnected trailer, etc.) and trigger emergency measures and/or alarms, etc. For semi-autonomous vehicles, the sensor system 10 can alert the vehicle driver and begin emergency reactions before the driver takes over control of the towing vehicle. For autonomous vehicles (i.e., driver-less towing vehicles), the sensor system 10 can react and control the towing vehicle by itself. Vehicle systems that can be enhanced through the integration and delivery of this data include without limitation: Engine Control Module 20a; Transmission Control Module 20b; Brake Control Module (including Differential Brake) 20c, Trailer Brake Control Module 20d, and Steering Control Module (including Active Front Steer) 20e, etc.

In some embodiments of the present invention, and as will be described below, the Force Sensor System 12 includes a primary force sensor, such as a double shear load hitch pin with strain gauge sensors and an axial cable connection. The strain gauge sensors are configured to measure lateral forces. Secondary force sensors, such as compression sensors (e.g., button sensors), may be incorporated in the hitch drawbar of a hitch apparatus to measure tongue weight, torque and transverse thrust (forces that act on the hitch structure as a result of trailer yaw and pitch, and rollover). Thin film strain gauge sensors (e.g., Nichrome (NiCr) thin film strain gauges, etc.), as well as metal foil type strain gauges may also be utilized.

The load cell hitch pin and drawbar tube force sensors are calibrated to compensate for the fitting tolerances inside of a hitch apparatus to ensure accuracy. Each force sensor provides direct steel-steel contact of the load bearing member (hitch pin and drawbar) to sensor to measure force vector in exact alignment to its source. This alignment system overcomes the loss of signal output from the force sensors due to variation of the angle of force applied and provides high accuracy and minimal requirement to compensate for variation in loading alignment.

Exemplary thin film strain gauge sensors and compression sensors that may be utilized as force sensors in accordance with embodiments of the present invention are available from various sources including, but not limited to Nichicon Corporation, Kyoto, Japan. Thin film strain gauge sensors and compression sensors that may be utilized in accordance with embodiments of the present invention are of sufficiently small size and mass such that mechanical characteristics of the various hitch apparatus components described herein remain relatively unchanged, although some structural changes may be needed in some cases, while preventing premature failure of the strain gauge due to oxidation, erosion, corrosion and the like processes.

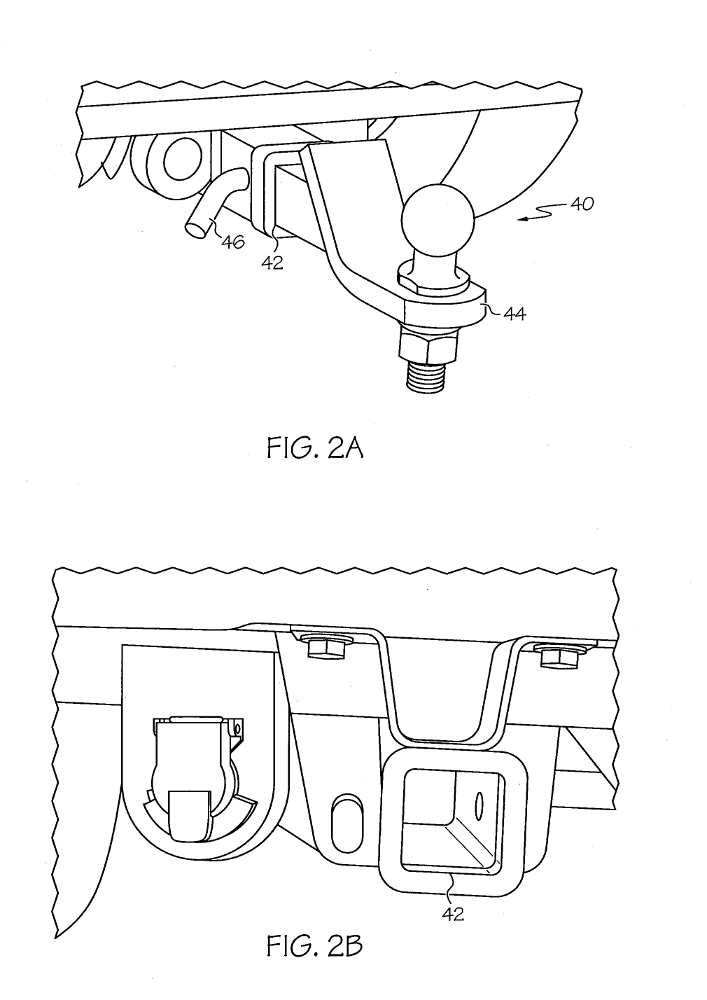

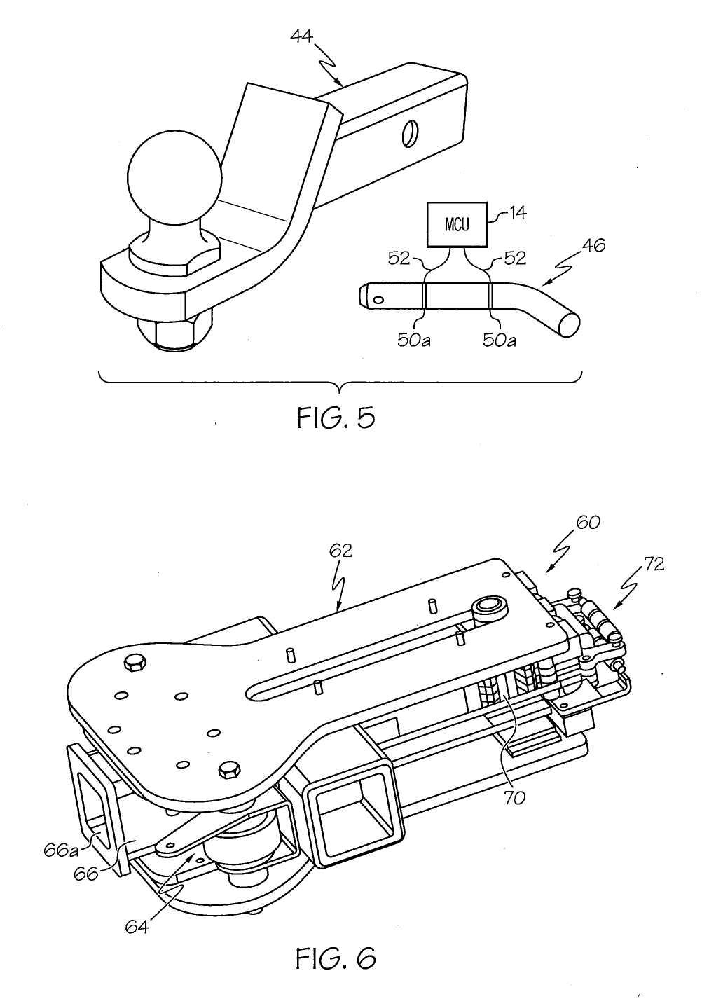

Embodiments of the present invention may be utilized with various types of hitch apparatus. For example, FIG. 2A illustrates a conventional hitch apparatus 40 that includes a receiver tube or drawbar 42 adapted to receive a coupling apparatus 44 therein. The coupling apparatus 44 is secured within the drawbar 42 via a pin 46. Various types of members/elements may serve the function of pin 46, as would be understood by those skilled in the art. According to embodiments of the present invention, the pin 46 includes one or more force sensors 50a, such as strain gauge sensors, etc., that form a load cell transducer (FIG. 5) configured to measure a force vector on the pin 46 during towing of a trailer or other vehicle attached to the coupling apparatus 44. In the illustrated embodiment, a pair of spaced-apart force sensors 50a are utilized. Each pin force sensor 50a is electrically connected to a microcontroller (MCU) unit 14 via a cable 52. However, in some embodiments, the pin force sensors 50a may wirelessly communicate with the microcontroller unit 14. The microcontroller unit 14 may be attached to or located within the coupling apparatus 44 or may be located on the towing vehicle V.

The microcontroller unit 14 is configured to receive force measurement data from the pin force sensors 50a and process the data for transfer to one or more vehicle control systems 20a-20e, for example, via a controller area network (CAN) bus associated with the vehicle. The vehicle control system(s) 20a-20e may then utilize this data to optimize various vehicle parameters during towing, such as torque distribution between the front and rear wheels, torque distribution between left and right wheels during braking, engine output, transmission speed, etc., in order to maintain a safe level of driving during towing.

In addition, an alarm may be associated with the microcontroller unit 14 and/or with a vehicle control system 20a-20e. The alarm may be configured to notify an operator of the vehicle V if a force from towing exceeds an allowed force. For example, in some embodiments of the present invention, a tongue weight alarm can be utilized to notify the operator that tongue weight caused by a trailer or towed vehicle is excessive.

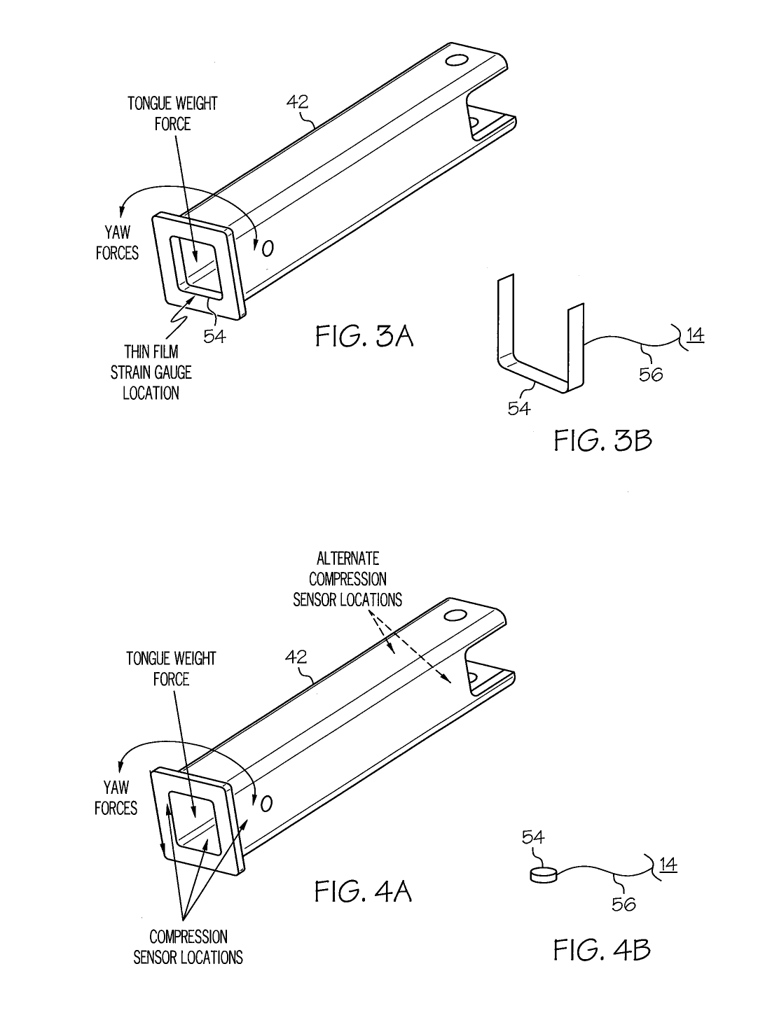

The drawbar 42 may include one or more force sensors 54 (FIGS. 3A-3B) that form a load cell transducer, each force sensor configured to measure a force vector on the drawbar 42 during towing of a trailer or other vehicle attached to the coupling apparatus 44 (FIG. 2A). The drawbar force sensors 54 may be thin film strain gauges sensors and/or compression sensors. In the illustrated embodiment of FIGS. 3A-3B, force sensors 54 may be positioned at various locations on the internal walls of the drawbar 42. Embodiments of the present invention are not limited to the location or configuration of the force sensors 54.

Each drawbar force sensor 54 is electrically connected to a microcontroller unit 14 via a cable 56. However, in some embodiments, the drawbar force sensors 54 may wirelessly communicate with the microcontroller unit 14. A microcontroller unit 14 associated with the drawbar force sensors 54 may be integral with the draw bar or may be located on the towing vehicle V. The microcontroller unit 14 is configured to receive force measurement data from each drawbar force sensor 54 and process the data for transfer to one or more vehicle control systems 20a-20e. The vehicle control system(s) 20a-20e may then utilize this data in combination with the data from the pin force sensors 50a to optimize various vehicle parameters, such as torque distribution between the front and rear wheels, torque distribution between left and right wheels during braking, and engine output, transmission speed, etc., in order to maintain a safe level of driving during towing.

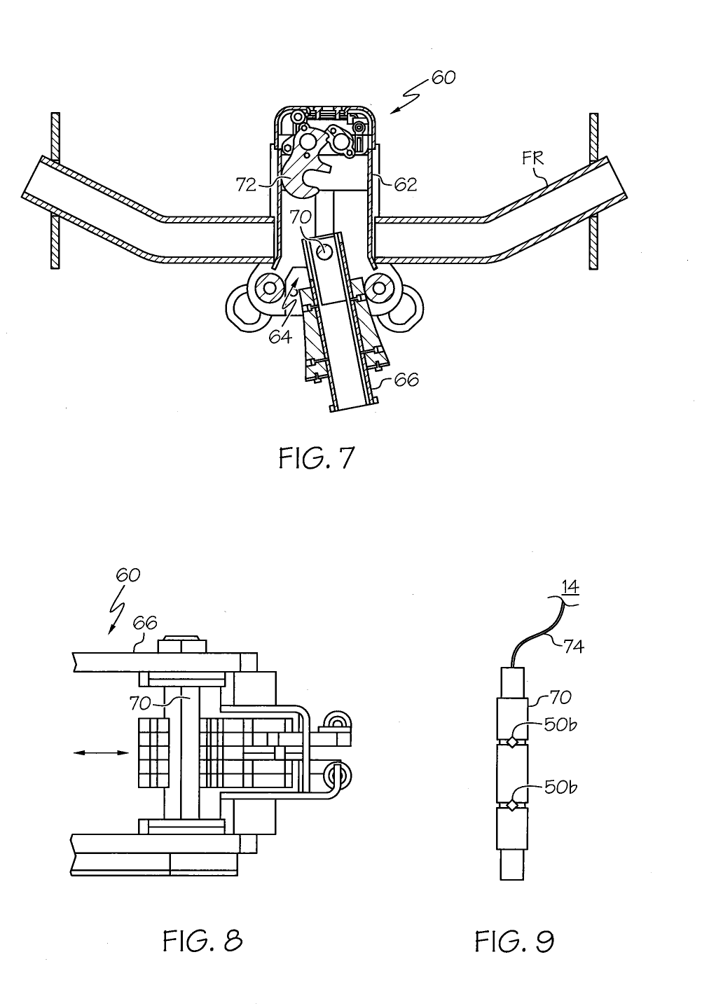

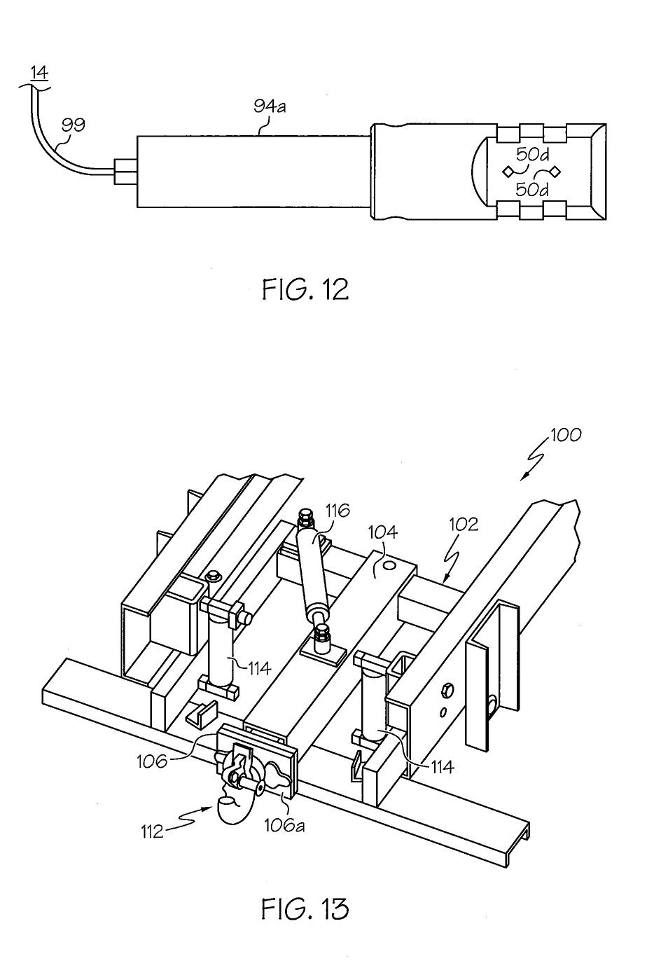

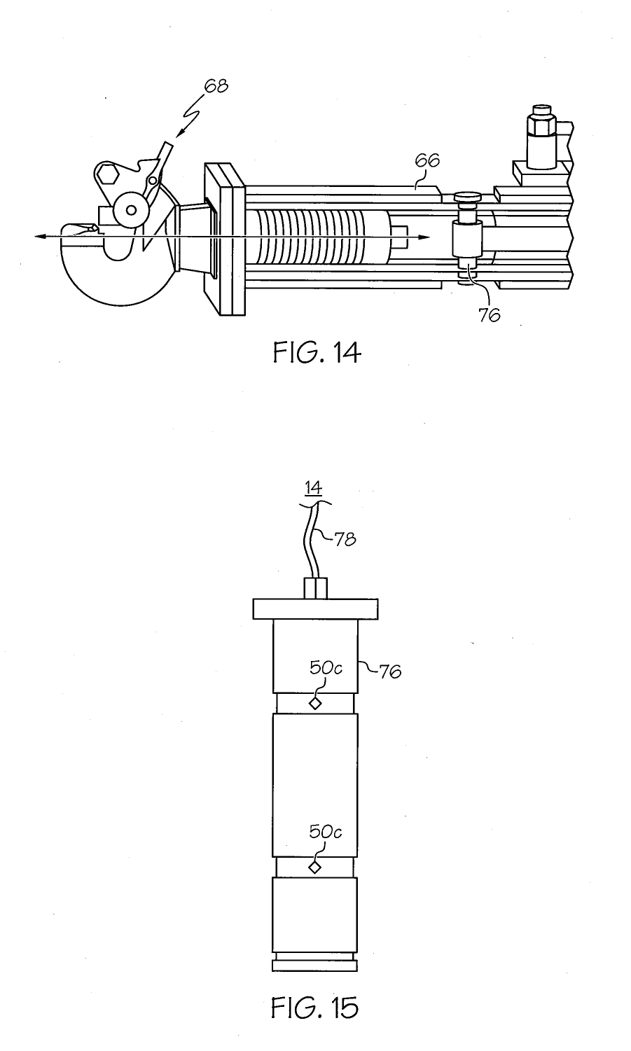

Referring to FIGS. 6-12, according to other embodiments of the present invention, a hitch apparatus 60 for a vehicle includes a microcontroller unit 14 (FIG. 1), a housing 62 that defines a cavity 64, and a drawbar 66 movably disposed within the cavity 64 and movable relative to the housing 62 between retracted (FIG. 6) and extended (FIG. 7) positions. A coupling apparatus 68 (FIG. 14) may be secured within the open distal end 66a of drawbar 66, as would be understood by one skilled in the art. The illustrated coupling apparatus 68 is a spring-cushioned pintle apparatus. However, various types of coupling apparatus may be secured within the drawbar 66 including, but not limited to, a tow ball (e.g., coupling apparatus 44 of FIG. 5), pintle clip, pintle hook, lunette ring, clevis pin device, etc.

Hitch apparatus 60 is described in detail in U.S. Patent Application Publication No. 2011/0221164, which is incorporated herein by reference in its entirety. The hitch apparatus 60 is configured to be installed on a vehicle, for example via welding, fasteners, or a combination of welding and fasteners. In some embodiments, the hitch apparatus 60 is mounted to a chassis/frame and/or underside of a vehicle V via a frame FR (FIG. 7), such as illustrated in U.S. Patent Application Publication No. 2011/0101647, which is incorporated herein by reference in its entirety. Moreover, a frame FR, if utilized with the illustrated hitch apparatus 60, can have various configurations and shapes to facilitate mounting of the hitch apparatus 60 to the underside or other portion of a particular vehicle. Furthermore, the hitch apparatus 60, according to some embodiments of the present invention, can be mounted to a vehicle without the use of a frame.

The illustrated hitch apparatus 60 includes a guide pin 70 associated with the drawbar 66 that limits how far the drawbar 66 can be extended from the housing 62. A locking mechanism 72 is operably secured to the housing 62 and releasably engages the guide pin 70 to maintain the drawbar 66 in a retracted position. The drawbar 66 may include a plurality of spaced-apart force sensors 54 (FIGS. 3A-3B and 4A-4B) that form a load cell transducer. Each drawbar force sensor is configured to measure a force vector on the drawbar 66 and each is electrically connected to the microcontroller unit 14 associated with the hitch apparatus 60 and/or a vehicle V to which the hitch apparatus 60 is attached (e.g., via a cable or wirelessly). Embodiments of the present invention are not limited to the illustrated location/configuration of the drawbar force sensors 54.

The guide pin 70 includes one or more force sensors 50b (FIG. 9) that form a load cell transducer, Each force sensor 50b is configured to measure a force vector on the guide pin 70 and is electrically connected to the microcontroller unit 14 (e.g., via a cable 74 or wirelessly). A coupling apparatus (e.g., 68, FIG. 14) is secured within the drawbar 66 via a pin 76 (FIG. 14). Various types of coupling apparatus may be secured within the drawbar 66. Moreover, various types of members/elements may serve the function of pin 76. The illustrated pin 76 includes a plurality of spaced-apart force sensors 50c (FIG. 15), each configured to measure a force vector on the pin 76 and each electrically connected to the microcontroller unit 14 (e.g., via a cable 78 or wirelessly).

The microcontroller unit 14 is configured to receive force measurement data from the drawbar force sensors 54, guide pin force sensors 50b, and coupling apparatus pin force sensors 50c, and process the data for transfer to one or more vehicle control systems 20a-20e (FIG. 1). In some embodiments, the microcontroller unit 14 is configured to communicate with the vehicle control system(s) 20a-20e via a controller area network (CAN) bus 18 (FIG. 1) associated with the vehicle. The vehicle control system(s) 20a-20e may then utilize this data to optimize various vehicle parameters during towing, such as torque distribution between the front and rear wheels, torque distribution between left and right wheels during braking, engine output, transmission speed, etc., in order to maintain a safe level of driving during towing.

In some embodiments, the hitch apparatus 60 may include an alarm associated with the microcontroller unit 14 and/or with a vehicle control system 20a-20e. The alarm may be configured to notify an operator of the vehicle V if a force from towing exceeds an allowed force. For example, in some embodiments of the present invention, a tongue weight alarm can be utilized to notify the operator that tongue weight caused by a trailer or towed vehicle is excessive.

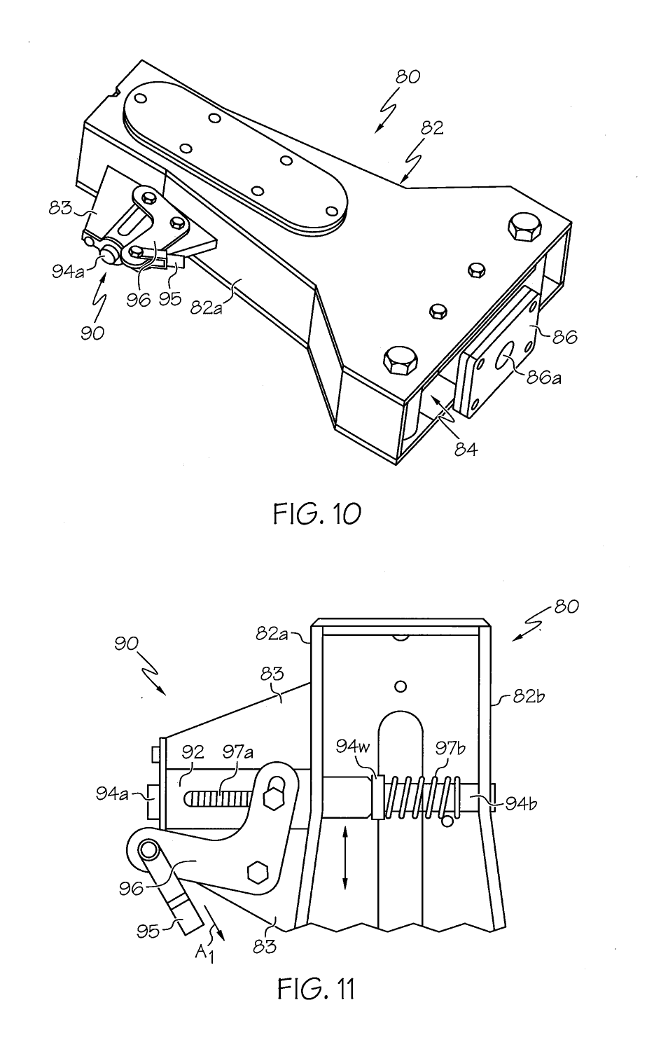

FIGS. 10-12 illustrate a hitch apparatus 80, according to other embodiments of the present invention. The hitch apparatus 80 is configured to be installed on a vehicle, for example via welding, fasteners, or a combination of welding and fasteners. In some embodiments, the hitch apparatus 80 is mounted to a chassis/frame and/or underside of a vehicle V via a frame FR (FIG. 7), such as illustrated in U.S. Patent Application Publication No. 2011/0101647. Moreover, a frame FR, if utilized with the illustrated hitch apparatus 80, can have various configurations and shapes to facilitate mounting of the hitch apparatus 80 to the underside or other portion of a particular vehicle V. Furthermore, the hitch apparatus 80, according to some embodiments of the present invention, can be mounted to a vehicle without the use of a frame.

The illustrated hitch apparatus 80 includes a housing 82 that defines a cavity 84, and a drawbar 86 movably disposed within the cavity 84 and movable relative to the housing 82 between retracted and extended positions. A locking mechanism 90 is operably secured to the housing 82 and includes cooperating first and second pins 94a, 94b configured to releasably engage the drawbar 86 and maintain the drawbar 86 in a retracted position. The illustrated locking mechanism 90 includes a cylinder 92 mounted to a housing side wall 82a via structural members 83. Movably disposed within the cylinder 92 is a first pin 94a that is operably associated with a second pin 94b that is retained in the drawbar 86 via washer 94w and spring 97b. In the illustrated embodiment, the spring 97b is coiled around the second pin 94b, however, other configurations are possible. The second pin 94b has a distal free end that extends through an aperture in a drawbar side portion and an aperture in the housing side wall 82b when the drawbar 86 is locked in the retracted position. When the first pin 94a is moved to the left against the force of spring 97a, away from the second pin 94b, the spring 97b urges the second pin 94b to the left to clear the housing side wall aperture such that the drawbar 86 can be extended. The second pin 94b remains with the drawbar 86 as the drawbar 86 is extended and retracted.

The locking mechanism 90 includes a handle 95 that, in response to user activation (e.g., a pulling force in the direction A₁, FIG. 11) is configured to move the first pin 94a left to clear the drawbar aperture. In the illustrated embodiment, a pulling force on the handle 95 in the direction Aₗ causes bracket 96 to pivot, which in turn, causes the first pin 94a to be moved away from the drawbar 86. The spring 97b urges the second pin 94b to the left to clear the housing sidewall aperture such that the drawbar 86 can be extended.

The first pin 94a includes one or more force sensors 50d that form a load cell transducer. Each force sensor 50d is configured to measure a force vector on the first pin 94a during towing of a trailer or other vehicle attached to the hitch apparatus 80. In the illustrated embodiment, the first pin 94a includes a pair of spaced-apart force sensors 50d. Each first pin force sensor 50d is electrically connected to a microcontroller unit 14 associated with the hitch apparatus and/or with a vehicle V to which the hitch apparatus 80 is attached via cable 99. In other embodiments, the first pin force sensors 50d may wirelessly communicate with the microcontroller unit 14. The microcontroller unit 14 is configured to receive force measurement data from each first pin force sensor 50d and process the data for transfer to one or more vehicle control systems 20a-20e. The vehicle control system(s) 20a-20e may then utilize this data along with data from strain gauges associated with drawbar 86 and a coupling apparatus to optimize various vehicle parameters during towing, such as torque distribution between the front and rear wheels, torque distribution between left and right wheels during braking, engine output, transmission speed, etc., in order to maintain a safe level of driving during towing.

In some embodiments, the hitch apparatus 80 may include an alarm associated with the microcontroller unit 14 and/or with a vehicle control system 20a-20e. The alarm may be configured to notify an operator of the vehicle V if a force from towing exceeds an allowed force. For example, in some embodiments of the present invention, a tongue weight alarm can be utilized to notify the operator that tongue weight caused by a trailer or towed vehicle is excessive.

FIG. 13 illustrates a hitch apparatus 100, according to other embodiments of the present invention. Hitch apparatus 100 is described in detail in U.S. Pat. No. 8,678,421 and U.S. Patent Application Publication No. 2014/0125034, which are incorporated herein by reference in their entireties. The hitch apparatus 100 includes a microcontroller unit 14 (FIG. 1), a frame 102 configured to be pivotably secured to a vehicle (for example the frame or other structural member(s) of a vehicle, etc.) and pivotable about a first axis (e.g., an axis that is substantially horizontal), a guide 104 pivotably secured to the frame 102 and pivotable about a second axis that is substantially transverse to the first axis, and a drawbar 106 movably secured to the guide 104 and movable relative to the guide 104 between retracted and extended positions.

In some embodiments of the present invention, the hitch apparatus 100 includes a user controlled positioning system configured to position the drawbar distal end 106a at a desired position within a three-dimensional coordinate system. In some embodiments, the positioning system includes at least one first actuator 114 configured to pivot the frame about the first axis, a second actuator 116 configured to pivot the guide about the second axis, and a third actuator (within the guide 104) configured to extend and retract the drawbar 106 relative to the guide 104. The first, second and third actuators may be hydraulic actuators, electrical actuators, or pneumatic actuators.

The drawbar 106 may include one or more force sensors forming a load cell transducer, as described above with respect to FIGS. 3A-3B and 4A-4B. Each force sensor is configured to measure a force vector on the drawbar 106, and each is electrically connected to the microcontroller unit 14. A locking mechanism is operably secured to the guide 104 and includes at least one locking pin (not shown). Drawbar 106 is secured within the guide 104 by drawbar pin 76 (FIG. 14). The drawbar pin 76 includes one or more force sensors forming a load cell transducer, as described above with respect to the guide pin 70 of FIGS. 8-9. Each force sensor is configured to measure a force vector on the drawbar locking pin 76, and each force sensor is electrically connected to the microcontroller unit 14 (e.g., via a cable or wirelessly). A coupling apparatus 112 is secured within the drawbar distal end 106a via fasteners, such as a plurality of bolts and nuts (not illustrated).

The microcontroller unit 14 is configured to receive force measurement data from each drawbar force sensor, each locking pin force sensor, and each coupling apparatus pin force sensor, and process the data for transfer to one or more vehicle control systems 20a-20e (FIG. 1). The vehicle control system(s) 20a-20e may then utilize this data to optimize various vehicle parameters during towing, such as torque distribution between the front and rear wheels, torque distribution between left and right wheels during braking, engine output, transmission speed, etc., in order to maintain a safe level of driving during towing.

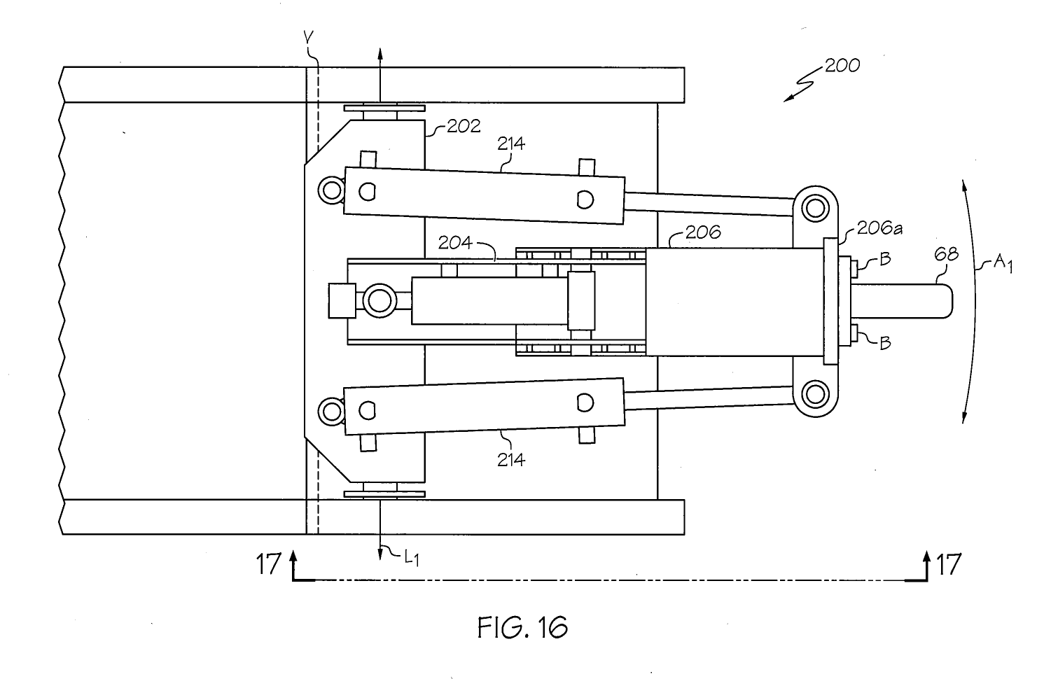

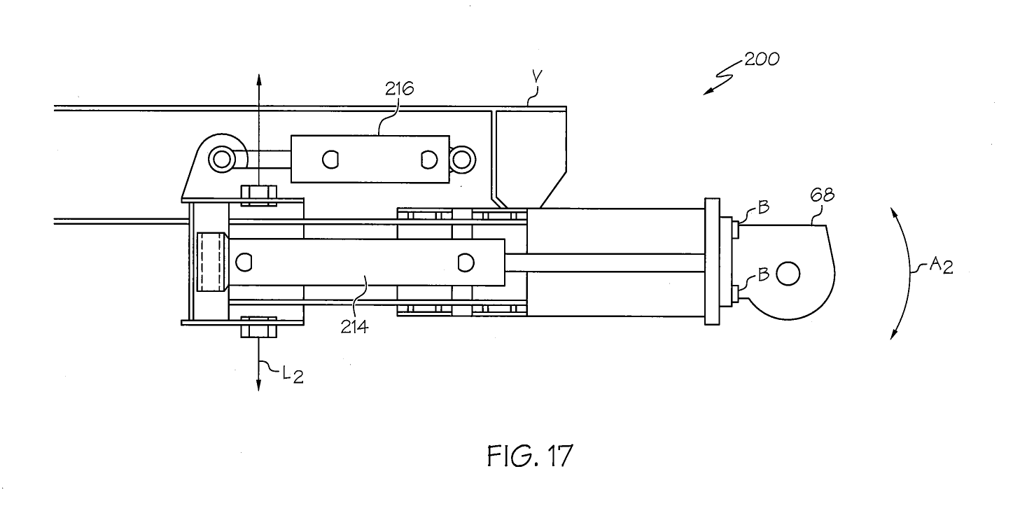

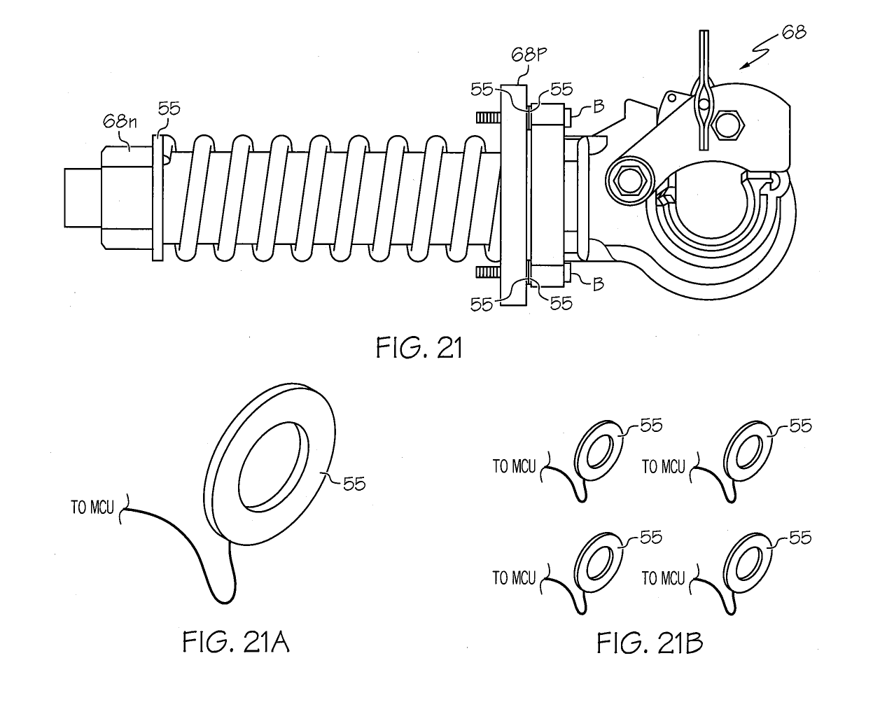

FIGS. 16-20 and 22 illustrate a hitch apparatus 200, according to other embodiments of the present invention. The hitch apparatus 200 includes a microcontroller unit 14 (FIG. 1), a frame 202 configured to be pivotably secured to a vehicle V (for example the frame or other structural member(s) of a vehicle, etc.) and pivotable about a first axis L₁ (e.g., an axis that is substantially horizontal), a guide 204 pivotably secured to the frame 202 and pivotable about a second axis L₂ (FIG. 17) that is substantially transverse to the first axis L₁, and a drawbar 206 movably secured to the guide 204 and movable relative to the guide 204 between retracted and extended positions. The distal end 206a of the drawbar 206 is configured to removably receive a coupling apparatus, such as the pintle hook apparatus 68 illustrated in FIGS. 14 and 21. The illustrated coupling apparatus 68 is secured to the distal end 206a of the drawbar 206 via fasteners, such as threaded bolts B. Various types of coupling apparatus may be secured to the distal end 206a of the drawbar 206 including, but not limited to, a tow ball (e.g., coupling apparatus 44 of FIG. 5), pintle clip, lunette ring, clevis pin device, etc.).

The illustrated hitch apparatus 200 includes a user controlled positioning system configured to position the drawbar distal end 206a at a desired position within a three-dimensional coordinate system. The illustrated positioning system includes a pair of actuators 214 that are configured to pivot the frame about the second axis L₂ (FIG. 17) as indicated by arrow Aₗ in FIG. 16, and to extend and retract the drawbar 206 relative to the guide 204. By extending one actuator 214 more than the other, the drawbar 206 can be pivoted. Thus, extension of the actuators 214 relative to each other causes pivotal movement about axis L₂.

Another actuator 216 associated with the guide 204 is configured to pivot the guide about the first axis L₁ (FIG. 16) so as to lower and raise the drawbar 206, as illustrated by arrow A₂ in FIG. 17. The actuators 214, 216 may be hydraulic actuators, electrical actuators, or pneumatic actuators, and are load bearing and locking actuators.

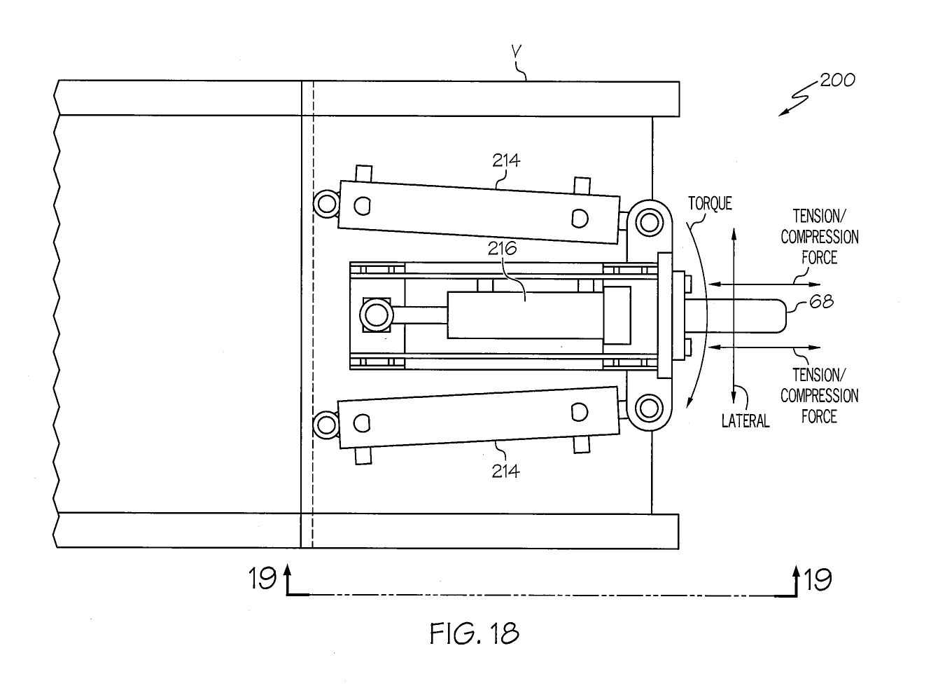

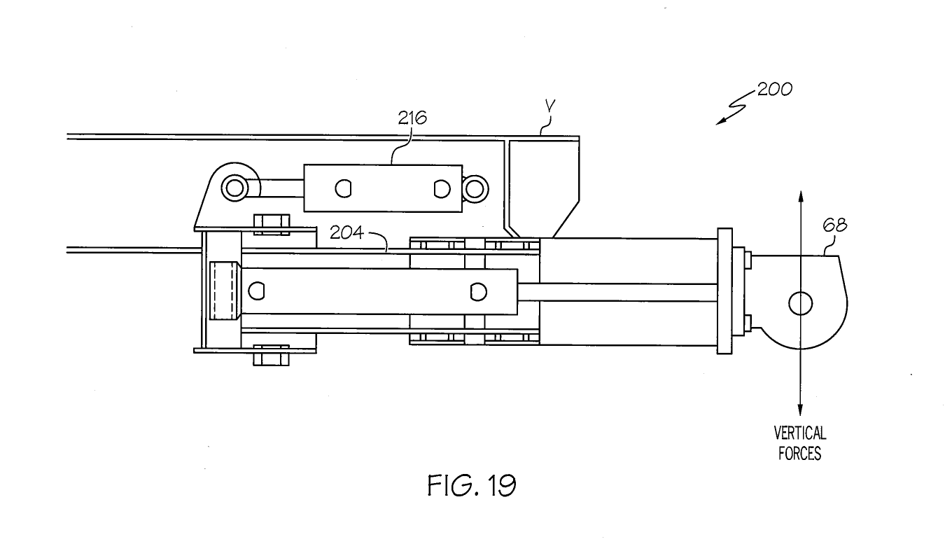

FIGS. 18 and 19 illustrate forces that can be incurred by the articulating hitch apparatus 200 of FIG. 16 when towing a trailer or other vehicle. The hitch apparatus 200 can experience tension and compression forces (FIG. 18) caused by vehicle acceleration and deceleration. The hitch apparatus 200 can experience lateral forces (FIG. 18) resulting from trailer yaw, and torque (FIG. 18) resulting from trailer/towed vehicle rotation about its lateral axis. In addition, the hitch apparatus can experience vertical forces (FIG. 19) such as the downward force of a trailer's tongue and the upward force on the trailer tongue resulting from uneven road surfaces or improper trailer loading, etc.

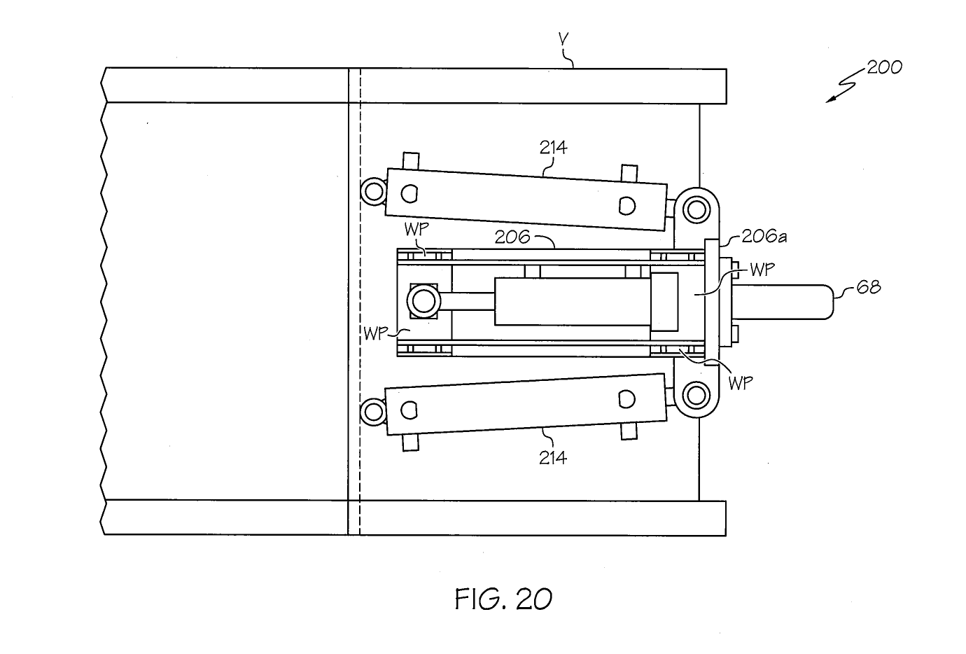

The hitch apparatus 200 may include various force sensors forming load cell transducers, as described above. For example, as illustrated in FIGS. 20 and 21, the coupling apparatus 68 may be secured to the drawbar distal end 206a via fasteners B and force sensors 55 (FIGS. 21 and 21B) such as thin film strain gauge washers may be inserted between the coupling apparatus 68 and the coupling apparatus mounting plate 68p. Each force sensor 55 is configured to measure a force vector on the drawbar distal end 206a, and each is electrically connected to the microcontroller unit 14.

In addition, force sensor 55 such as a thin film strain gauge washer may be located at the retaining nut 68n of the coupling apparatus 68 (FIGS. 21 and 21A). The force sensor 55 located at the retaining nut 68n is configured to measure a force vector on the coupling apparatus 68 and is electrically connected to the microcontroller unit 14.

Wear pad load cells WP comprising one or more compression sensors may be associated with the drawbar 206 in various locations, as illustrated in FIG. 20. Such compression sensors are configured to measure forces on the drawbar 206, as described above, and are also connected to the microcontroller unit 14. Wear pad load cells WP may be affixed to the guide 204 or to the drawbar 206. For example, in some embodiments one or more wear pad load cells WP may be secured to the drawbar 206 and one or more wear pad load cells may be secured to the guide 204. Various combinations of wear pad load cells WP may be utilized, as well.

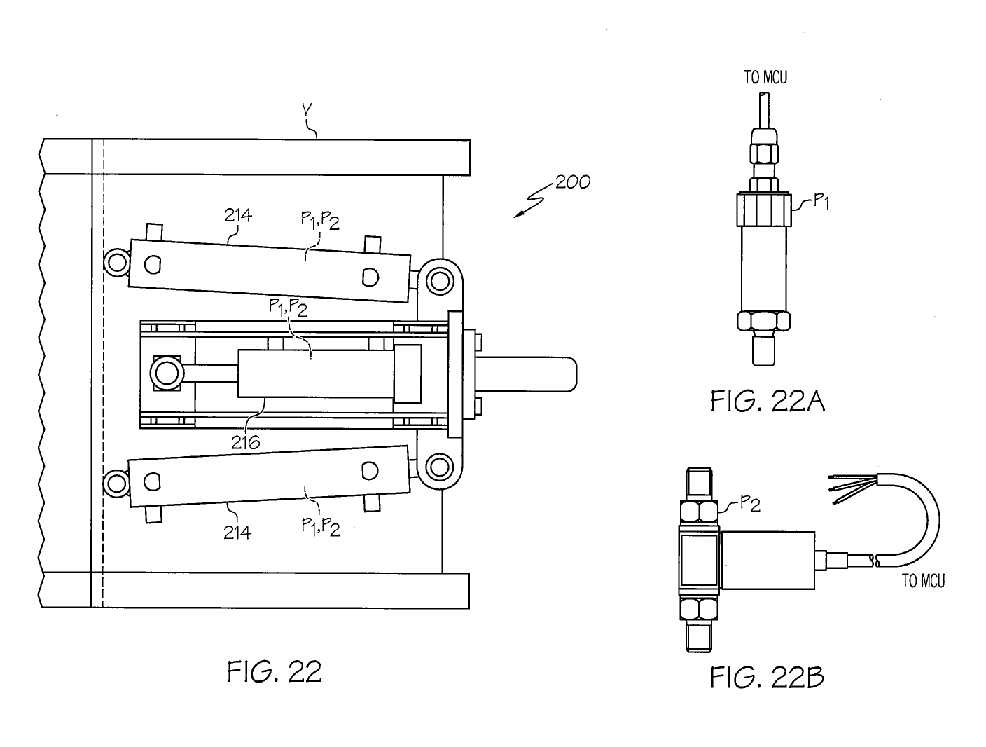

Referring to FIG. 22, in some embodiments, the actuators 214, 216 are hydraulic or pneumatic actuators and differential pressure transducers are in fluid communication with the hydraulic fluid or air/gas within the actuators 214, 216 to measure forces on the actuators 214, 216. Mechanical forces acting on the hitch apparatus 200 during a towing operation can cause changes in pressure of the hydraulic fluid or air/gas within the actuators 214, 216 which can be measured via the differential pressure transducers. Pressure changes are converted into an electrical signal by deformation of a strain gauge in the diaphragm of a pressure transducer. Various types of pressure transducers can be utilized in accordance with embodiments of the present invention. FIG. 22A illustrates a pressure transducer P₁ that is directly mounted within a port of an actuator 214, 216. FIG. 22B illustrates an in-line mounted pressure transducer P₂. Exemplary differential pressure transducers that may be utilized in accordance with embodiments of the present invention are available from Quality Hydraulics & Pneumatics, Inc., Mundelein, Ill., as well as from other sources.

In some embodiments of the present invention, data received from various force sensors (e.g., 50a, 50b, 50c, 50d, 54, 55, P₁, P₂) via a CAN bus can be utilized by autonomous vehicle control systems to assist in the control of an autonomous vehicle pulling a trailer or other towed vehicle. The various force sensors can measure dynamic forces acting on the autonomous vehicle due to a trailer/other towed vehicle and provide data to control systems to adjust the vehicle speed, steering braking, etc., of the vehicle operating as part of an autonomous convoy of vehicles.

In addition, data received from various force sensors (e.g., 50a, 50b, 50c, 50d, 54, 55, P₁, P₂) via a CAN bus can be utilized by semi-autonomous vehicle control systems to assist in the control of a semi-autonomous vehicle pulling a trailer or other towed vehicle.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the teachings and advantages of this invention. Accordingly, all such modifications are intended to be included within the scope of this invention as defined in the claims. The invention is defined by the following claims, with equivalents of the claims to be included therein.

That which is claimed is:

1. A hitch apparatus for a vehicle having at least one vehicle control system, the hitch apparatus comprising:
a microcontroller unit;
a drawbar; and
a coupling apparatus secured within the drawbar via a pin, wherein the pin comprises one or more force sensors, each pin force sensor configured to measure a force vector on the pin, and wherein each pin force sensor is electrically connected to the microcontroller unit,
wherein the microcontroller unit is configured to receive force measurement data from each pin force sensor and process the data for transfer to the at least one vehicle control system.

2. The hitch apparatus of claim 1, wherein the microcontroller unit is configured to communicate with the at least one vehicle control system via a controller area network (CAN) bus associated with the vehicle.

3. The hitch apparatus of claim 1, wherein the microcontroller unit is configured to determine if a threshold force on the pin has been exceeded and trigger a corrective action by the vehicle control system in response to determining that the threshold force has been exceeded.

4. The hitch apparatus of claim 1, wherein the drawbar comprises one or more force sensors, each drawbar force sensor configured to measure a force vector on the drawbar, wherein each drawbar force sensor is electrically connected to the microcontroller unit, and wherein the microcontroller unit is configured to receive force measurement data from each drawbar force sensor and process the data for transfer to the at least one vehicle control system.

5. The hitch apparatus of claim 4, wherein the microcontroller unit is configured to determine if a threshold force on the drawbar has been exceeded and trigger a corrective action by the vehicle control system in response to determining that the threshold force has been exceeded.

6. The hitch apparatus of claim 1, wherein the hitch apparatus comprises a housing that defines a cavity, and wherein the drawbar is movably disposed within the cavity and movable relative to the housing between retracted and extended positions.

7. The hitch apparatus of claim 6, further comprising a guide pin associated with the drawbar that limits how far the drawbar can be extended from the housing, and a locking mechanism operably secured to the housing that releasably engages the guide pin to maintain the drawbar in a retracted position, wherein the guide pin comprises one or more force sensors, each guide pin force sensor configured to measure a force vector on the guide pin, wherein each guide pin force sensor is electrically connected to the microcontroller unit, and wherein the microcontroller unit is configured to receive force measurement data from each guide pin force sensor and process the data for transfer to the at least one vehicle control system.

8. The hitch apparatus of claim 7, wherein the microcontroller unit is configured to determine if a threshold force on the guide pin has been exceeded and trigger a corrective action by the vehicle control system in response to determining that the threshold force has been exceeded.

9. The hitch apparatus of claim 6, further comprising a locking mechanism operably secured to the housing, wherein the locking mechanism comprises a locking pin configured to releasably engage the drawbar and maintain the drawbar in a retracted position, wherein the locking pin comprises one or more force sensors, each locking pin force sensor configured to measure a force vector on the locking pin, wherein each locking pin force sensor is electrically connected to the microcontroller unit, and wherein the microcontroller unit is configured to receive force measurement data from each locking pin force sensor and process the data for transfer to the at least one vehicle control system.

10. The hitch apparatus of claim 9, wherein the microcontroller unit is configured to determine if a threshold force on the locking pin has been exceeded and trigger a corrective action by the vehicle control system in response to determining that the threshold force has been exceeded.

11. The hitch apparatus of claim 1, further comprising an alarm in communication with the microcontroller unit, wherein the alarm is configured to notify an operator of the vehicle if a force on the pin exceeds an allowed force.

12. A hitch apparatus for a vehicle, the hitch apparatus comprising:
a microcontroller unit;
a drawbar comprising one or more force sensors, each drawbar force sensor configured to measure a force vector on the drawbar, wherein each drawbar force sensor is electrically connected to the microcontroller unit via a first electrical cable; and
a coupling apparatus secured within the drawbar via a pin, wherein the pin comprises one or more force sensors, each pin force sensor configured to measure a force vector on the pin, and wherein each pin force sensor is electrically connected to the microcontroller unit via a second electrical cable,
wherein the microcontroller unit is configured to receive force measurement data from each drawbar force sensor and each pin force sensor and process the data for transfer to a vehicle control system.

13. The hitch apparatus of claim 12, wherein the microcontroller unit is configured to determine if a threshold force on the drawbar and/or on the pin has been exceeded and trigger a corrective action in response to determining that the threshold force has been exceeded.

14. A hitch apparatus for a vehicle, the hitch apparatus comprising:
a microcontroller unit;
a housing that defines a cavity;
a drawbar movably disposed within the cavity and movable relative to the housing between retracted and extended positions, wherein the drawbar comprises one or more force sensors, each drawbar force sensor configured to measure a force vector on the drawbar, wherein each drawbar force sensor is electrically connected to the microcontroller unit;
a guide pin associated with the drawbar that limits how far the drawbar can be extended from the housing;
a locking mechanism operably secured to the housing that releasably engages the guide pin to maintain the drawbar in a retracted position, wherein the guide pin comprises one or more force sensors, each guide pin force sensor configured to measure a force vector on the guide pin, and wherein each guide pin force sensor is electrically connected to the microcontroller unit; and
wherein the microcontroller unit is configured to receive force measurement data from each drawbar force sensor and each guide pin force sensor, and process the data for transfer to a vehicle control system.

15. The hitch apparatus of claim 14, wherein the microcontroller unit is configured to determine if a threshold force on the drawbar and/or on the guide pin and/or on the pin has been exceeded and trigger a corrective action in response to determining that the threshold force has been exceeded.

16. A hitch apparatus for a vehicle, the hitch apparatus comprising:
a microcontroller unit;
a housing that defines a cavity;
a drawbar movably disposed within the cavity and movable relative to the housing between retracted and extended positions, wherein the drawbar comprises one or more force sensors, each drawbar force sensor configured to measure a force vector on the drawbar, wherein each drawbar force sensor is electrically connected to the microcontroller unit;
a locking mechanism operably secured to the housing, wherein the locking mechanism comprises a locking pin configured to releasably engage the drawbar and maintain the drawbar in a retracted position, wherein the locking pin comprises one or more force sensors, each locking pin force sensor configured to measure a force vector on the locking pin, wherein each locking pin force sensor is electrically connected to the microcontroller unit; and
a coupling apparatus secured within the drawbar via a pin, wherein the pin comprises one or more force sensors, each pin force sensor configured to measure a force vector on the pin, wherein each pin force sensor is electrically connected to the microcontroller unit,
wherein the microcontroller unit is configured to receive force measurement data from each drawbar force sensor, each locking pin force sensor, and each pin force sensor, and process the data for transfer to a vehicle control system.

17. The hitch apparatus of claim 16, wherein the microcontroller unit is configured to determine if a threshold force on the drawbar and/or on the locking pin and/or on the pin has been exceeded and trigger a corrective action in response to determining that the threshold force has been exceeded.

18. A hitch apparatus for a vehicle, the hitch apparatus comprising:
a microcontroller unit;
a frame configured to be pivotably secured to the vehicle, wherein the frame is pivotable about a first axis;
a guide pivotably secured to the frame and pivotable about a second axis that is substantially transverse to the first axis;
a drawbar movably secured to the guide and movable relative to the guide between retracted and extended positions, wherein the drawbar comprises a distal end configured to removably receive a coupling apparatus, wherein the drawbar comprises one or more force sensors, each drawbar force sensor configured to measure a force vector on the drawbar, and wherein each drawbar force sensor is electrically connected to the microcontroller unit,
wherein the microcontroller unit is configured to receive force measurement data from each drawbar force sensor and process the data for transfer to a vehicle control system.

19. The hitch apparatus of claim 18, further comprising a drawbar pin operably secured to the drawbar, wherein the drawbar pin comprises one or more force sensors, each drawbar pin force sensor configured to measure a force vector on the drawbar pin, wherein each drawbar pin force sensor is electrically connected to the microcontroller unit, and wherein the microcontroller unit is configured to receive force measurement data from each drawbar pin force sensor and process the data for transfer to the vehicle control system.

20. The hitch apparatus of claim 18, further comprising a user controlled positioning system configured to position the drawbar distal end at a desired position within a three-dimensional coordinate system.

21. The hitch apparatus of claim 20, wherein the positioning system comprises:
at least one first actuator configured to pivot the frame about the first axis; and
at least one second actuator configured to pivot the guide about the second axis and to extend and retract the drawbar relative to the guide,
wherein the at least one first and second actuators are hydraulic actuators, electrical actuators, or pneumatic actuators.

22. The hitch apparatus of claim 18, wherein the microcontroller unit is configured to determine if a threshold force on the drawbar has been exceeded and trigger a corrective action by the vehicle control system in response to determining that the threshold force has been exceeded.

23. The hitch apparatus of claim 18, further comprising a coupling apparatus secured to the drawbar distal end via at least one fastener, wherein each fastener comprises a force sensor configured to measure a force vector on the fastener, wherein each force sensor is electrically connected to the microcontroller unit, and wherein the microcontroller unit is configured to receive force measurement data from each force sensor and process the data for transfer to the vehicle control system.

24. The hitch apparatus of claim 23, wherein each fastener force sensor comprises a thin film washer.

25. The hitch apparatus of claim 21, wherein the at least one first actuator and/or the at least one second actuator are hydraulic or pneumatic actuators and further comprising a respective differential pressure transducer in fluid communication with the at least one first actuator and the at least one second actuator to measure forces on the at least one first and second actuators.

26. The hitch apparatus of claim 18, further comprising at least one wear pad load cell associated with the drawbar and configured to measure a force vector on the drawbar, wherein each wear pad load cell is electrically connected to the microcontroller unit, and wherein the microcontroller unit is configured to receive force measurement data from each wear pad load cell and process the data for transfer to the vehicle control system.

27. A hitch apparatus for a vehicle, the hitch apparatus comprising:
a microcontroller unit;
a frame configured to be pivotably secured to the vehicle, wherein the frame is pivotable about a first axis;
a guide pivotably secured to the frame and pivotable about a second axis that is substantially transverse to the first axis;
a drawbar movably secured to the guide and movable relative to the guide between retracted and extended positions, wherein the drawbar comprises a distal end configured to removably receive a coupling apparatus; and
a user controlled positioning system configured to position the drawbar distal end at a desired position within a three-dimensional coordinate system, wherein the positioning system comprises:
at least one first actuator configured to pivot the frame about the first axis, wherein the at least one first actuator is a hydraulic or pneumatic actuator;
a first differential pressure transducer in fluid communication with the at least one first actuator and configured to measure forces on the at least one first actuator, wherein the first differential pressure transducer is electrically connected to the microcontroller unit;
at least one second actuator configured to pivot the guide about the second axis and to extend and retract the drawbar relative to the guide, wherein the at least one second actuator is a hydraulic or pneumatic actuator; and
a second differential pressure transducer in fluid communication with the at least one second actuator and configured to measure forces on the at least one second actuator, wherein the second differential pressure transducer is electrically connected to the microcontroller unit;
wherein the microcontroller unit is configured to receive force measurement data from the first and second differential pressure transducers and process the data for transfer to a vehicle control system.

28. The hitch apparatus of claim 27, wherein the microcontroller unit is configured to determine if a threshold force on the at least one first actuator and/or on the at least one second actuator has been exceeded and trigger a corrective action by the vehicle control system in response to determining that the threshold force has been exceeded.
